(19) United States
(12) Patent Application Publication
(10) Pub. No.: US 2008/0247454 A1
(43) Pub. Date: Oct. 9, 2008

(54) Video signal timing adjustment

(76) Inventors: Aleksandr Movshovich, Santa Clara, CA (US); Advait Mogre, Sunnyvale, CA (US)

Correspondence Address: BRAKE HUGHES BELLERMANN LLP;c/o Intellevate, P.O. Box 52050, Minneapolis, MN, 55402, US

(21) Appl. No.: 11/784,050

(22) Filed: Apr. 5, 2007

(51) Int. Cl. H04N 11/04

(52) U.S. Cl. 375/240.01; 375/E07.267

(57) ABSTRACT

A method is disclosed herein, which may include receiving a video signal after a computer system is reset, automatically determining that an actual timing relation between the active video data and the synchronization pulse data deviates from the nominal relation by more than a tolerance value, and adjusting the actual timing relation to fall within the tolerance value. The video signal may include active video data and synchronization pulse data. A video format may define a nominal timing relation between the active video data and the synchronization pulse data.

### TECHNICAL FIELD

This description relates to video signal processing and, more particularly, to correcting timing errors in a video signal.

### BACKGROUND

Video images can be represented in a variety of formats, including raster frames. Raster frames represent video images as a series of pixel values corresponding to pixels which make up the video image. The video image typically includes a number of horizontal rows or lines of pixels defined by a video format. The length of the lines typically defines a width or a horizontal resolution of the video image, and the number of lines typically defines a height or a vertical resolution of the image. Thus, a 640×480 video image would include 480 lines which are each 640 pixels long.

In a raster frame, the pixel values of a horizontal line are typically ordered from left to right and lines are ordered from top to bottom of the video image. Thus, the first pixel value in a raster frame may correspond to the top-left pixel, and the successive pixel values may correspond to pixels successively located to the right along the top of the image, until a pixel value corresponding to the top-right pixel. Then, the pixel values in the raster frame may correspond to descending rows, with the pixels in each row located successively to the right. The last pixel value in the raster frame should correspond to the pixel located in the lower right of the image. Pixel values can control the brightness of a pixel. Thus, in one example, if a pixel value is zero, then the corresponding pixel in the display may be set to the background color.

When raster frames are processed by a video processor, each raster frame is typically separated from the other raster frames by a time delay, and each line or row within the raster frame is typically separated from the other lines or rows by a time delay. The raster frames are typically accompanied by a synchronization signal. The synchronization signal typically includes vertical synchronization pulses preceding each raster frame, and horizontal synchronization pulses preceding each line. A video format typically defines a nominal time window within which to recognize data values based on the vertical synchronization pulses and horizontal synchronization pulses. Thus, the video format in combination with the vertical synchronization pulse determine which pixel data values correspond to the first and successive lines or rows in the video image, and the video format in combination with the horizontal synchronization pulses determine which pixel data values correspond to which pixels within the rows or lines.

If the timing of the raster frame is not properly aligned with the vertical synchronization pulses, then the graphics processor may assign the wrong line of pixels to data values within the raster frame, causing the video image to shift up or down. If the raster frame is not properly aligned with the horizontal synchronization pulses, then the graphics processor may assign data values within the raster frame to the wrong pixel within a line, causing the video image to shift left or right.

### SUMMARY

According to one example embodiment, a method may include receiving a video signal after a computer system is reset, automatically determining that an actual timing relation between the active video data and the synchronization pulse data deviates from the nominal relation by more than a tolerance value, and adjusting the actual timing relation to fall within the tolerance value. The video signal may include active video data and synchronization pulse data. A video format may define a nominal timing relation between the active video data and the synchronization pulse data.

According to another example embodiment, a method may include receiving active video data and synchronization data determining at least one search region window of the active video data based at least in part on the synchronization data and a time delay factor, comparing an amplitude of the active video data in the at least one search region window to a noise threshold, and adjusting the time delay factor based at least in part on the comparison. At least one search region window may be outside of a nominal time window of the active video data. The at least one search region window, the nominal active video data window, and the time delay factor may each be defined at least in part by a video format.

Another example embodiment may include a chip comprising a video signal input port, a synchronization pulse input port, a clock signal generator, a comparator, a delay block, and an output block. The video signal input port may receive an active video input signal for generating frames of an image on a display device. The synchronization pulse input port may receive a synchronization pulse input signal for controlling the position of the image on the display device. The clock signal generator may generate a clock signal. The comparator may be configured to receive the video input signal, the synchronization pulse input signal, and the clock signal. The comparator may be further configured to determine at least one search region window based on a video format and the synchronization pulse signal, and determine a timing error based on active video input data included in the active video input signal being received within the at least one search region window. The delay block may be configured to delay the video input signal relative to the synchronization pulse input signal based on the timing error. The output block may be configured to output the delayed video signal for display on the display device.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a video display system including a computer, a chip, such as a graphics processing chip, and a display device.

FIG. 2 is a timing diagram showing active video data and synchronization pulse data, including a vertical synchronization pulse and horizontal synchronization pulses, in which an actual timing relation between the active video data and the synchronization pulse data conforms to a nominal timing relation.

FIG. 3 is a timing diagram showing active video data and synchronization pulse data, including the vertical synchronization pulse and the horizontal synchronization pulses, in which the actual timing relation between the active video data and the synchronization pulse data deviates from a nominal timing relation.

FIG. 4A shows a timing diagram with a left search region window and a right search region window, along with a graphical representation of four search regions and a nominal active video region of the display.

FIG. 4B shows a timing diagram with a top search region window, along with the graphical representation of the four search regions and the nominal active video region of the display.

FIG. 4C shows a timing diagram with a bottom search region window, along with the graphical representation of the four search regions and the nominal active video region of the display.

FIG. 5 shows a graphical representation of the four search regions of the display, along with pixel values for a vertical line within the left search region, pixel values for a horizontal line within the bottom search region, and line signal amplitude values for the left search region, right search region, top search region, and bottom search region.

FIG. 6 is a flowchart showing a method according to an example embodiment.

FIGS. 7A through 7D show the display with the four search regions and an object moving against the background into and out of the search regions.

FIG. 8 is a flowchart showing another method according to another example embodiment.

FIG. 9 is a flowchart showing another method according to another example embodiment.

### DETAILED DESCRIPTION

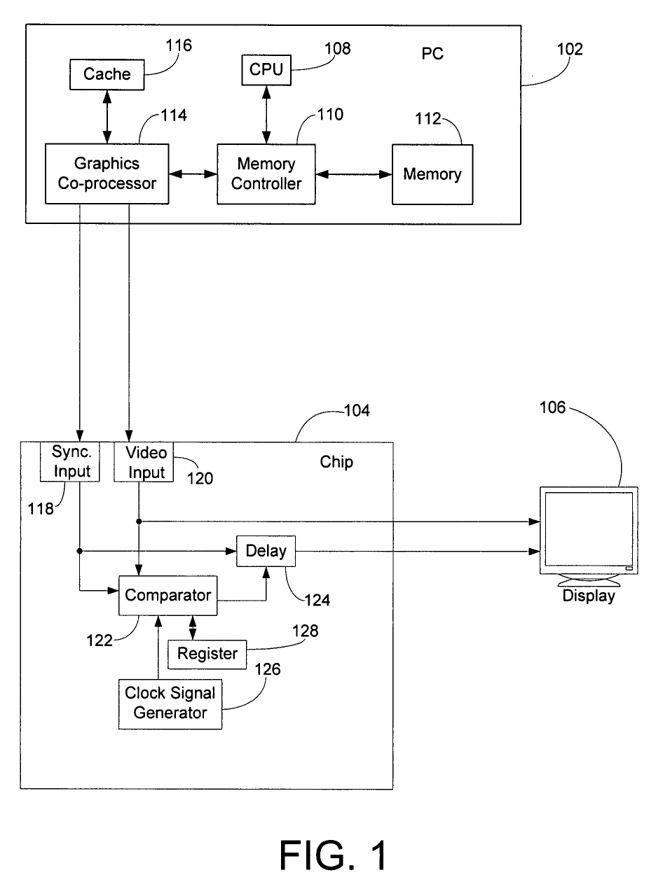

FIG. 1 is a block diagram of a video display system including a computer 102, a video correction chip 104, such as a graphics processing chip, and a display 106. The personal computer 102 may include a central processing unit 108 or microprocessor coupled to a memory controller 10, according to an example embodiment. The memory controller 110 may be coupled to both a memory 112 of the personal computer 102 and to a graphics co-processor 114. The coupling of the memory controller 110 to the memory 112 and the graphics co-processor 114 may allow the graphics co-processor 114 to consult the memory 112 without burdening the central processing unit 108, according to an example embodiment.

The graphics co-processor 114 may be responsible for sending video and synchronization data to a display device 106, so that video images can be presented on the display device 106. Prior to display on the display device the video and synchronization signals can be processed by the video correction chip 104 to correct errors between the timing of the video and synchronization data. For example, the graphics co-processor 114 may output active video data for displaying as raster frames and may send the data for the raster frames, along with synchronization pulse data, to the chip 104. When processing video data, the graphics co-processor 114 may utilize cache 116, which may be coupled to or part of the graphics co-processor 114. The active video data output by the graphics controller is active video data because video images are formed by writing successive raster frames to the display device 106 to create a video image, and each frame is composed of a number of individual lines. A period of time between successive frames exists during which active video is not transmitted, and, likewise a period of time between successive lines within a frame exists during which active video is not transmitted. Because of these interstitial idle or inactive periods, the video data is active video data.

While FIG. 1 shows one channel for transmitting the active video data and one channel for transmitting the synchronization pulse data, a variety of physical media may be used for transmitting these data. For example, a separate wire could be used for transmitting each of the active video data and the synchronization data, or one wire could be used to transmit both the video data and the synchronization data using frequency division multiplexing or time division multiplexing. Or, either or both of the video data and synchronization data could be wirelessly transmitted to the chip 104, and could be separated by frequency division multiplexing, time division multiplexing, or code division multiplexing.

Also, while one channel may be used to transmit one set of video data for black and white images, three sets of video data may be used to transmit color images. For example, three raster frames may be simultaneously transmitted to transmit red, green, and blue contributions to the video image. The red, green, and blue raster frames may be transmitted along separate wires, or may be transmitted along the same wire or using a wireless interface and separated by frequency division multiplexing, time division multiplexing, or code division multiplexing, for example. Sets of colors other than red, green, and blue may also be used.

The chip 104, which may be a component of the display device 106, may be configured to receive the active video data and the synchronization data. For example, the chip 104 may include a video signal input port 120 for receiving an active video input signal, such as the active video data sent by the graphics co-processor 114. The active video input signal may be used to generate frames, such as raster frames, of an image on the display 106. In this example, the chip 104 may also include a synchronization pulse input port 118 for receiving a synchronization pulse input signal, such as the synchronization pulse data sent by the graphics co-processor 114. The synchronization pulse input signal may be used to control the position of the image on the display 106. It should be understood that chip 104 can be a standalone chip but also can be electronic circuitry located on a chip that contains circuits for performing other additional functions. In addition, although denominated a “chip” for convenience and readability here chip 104 can be electronic circuitry embodied in any from, which may include component that are not embodied on a semiconductor chip.

The chip 104 may be configured to monitor and adjust the timing relation between the active video data and the synchronization pulse data on a continuous or periodic basis, according to an example embodiment. For example, the chip 104 may be configured to monitor and adjust the timing relation during use of the personal computer 102, in addition to or as a substitute for monitoring and adjusting the timing relation at startup of the personal computer 102 or when a user requests alignment of the video image.

The video input signal port 120 may forward the active video input signal to the display 106, and may also forward the active video input signal to a comparator 122. The synchronization pulse input port 118 may forward the synchronization pulse data to the comparator 122 and to a delay element 124. The delay element 124 may forward the synchronization pulse input to the display 106 after delaying the synchronization pulse input signal based on a timing error between the synchronization pulse input signal and the active video input signal. The timing error may be determined by the comparator 122, according to an example embodiment.

The comparator 122 may receive the video input signal, the synchronization pulse input signal, and a clock signal from a clock signal generator 126 included in the chip 104. The comparator 122 may determine at least one search region window based on a video format and the synchronization pulse input signal, and may determine a timing error based on active video input data included in the active video input signal being received within the at least one search region window. The comparator 122 may store the timing error in a register 128, and may consult the register 128 for past timing errors. These processes are described in further detail below.

According to another example embodiment, the synchronization pulse input port 118 may forward the synchronization pulse data directly to the display 104, and the video input signal port 120 may forward the active video input signal to the delay element 124. In this example embodiment, the delay element 124 may forward the active video input signal to the display 106 after delaying the active video input signal, instead of the synchronization pulse input signal, based on a timing error determined by the comparator 122. The timing error in this example may be equal in magnitude, but opposite in sign, to the timing error in the previous example.

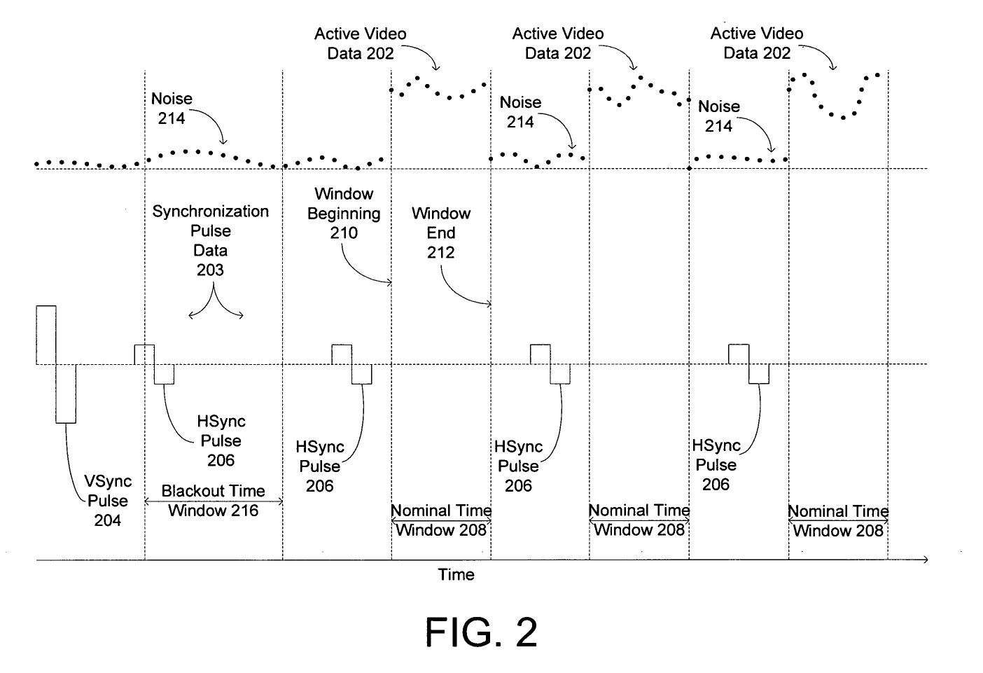

FIG. 2 is a timing diagram showing active video data 202 and synchronization pulse data 203, including a vertical synchronization pulse (VSync pulse) 204 and horizontal synchronization pulses (HSync pulses) 206, in which an actual timing relation between the active video data 202 and the synchronization pulse data 203 conforms to a nominal timing relation. In this example, the vertical synchronization pulse 204 and the horizontal synchronization pulses 206 may be part of the synchronization pulse data 203 received by the synchronization pulse input port 118. It should be noted that the timing diagram shown in FIG. 2 is not shown to scale, and the relative time delays between the horizontal synchronization pulses 206 and the vertical synchronization pulse 204 are longer or shorter than those shown in FIG. 2. Also, the nominal time windows 208 may be longer or shorter than those shown in FIG. 2.

While the vertical synchronization pulse 204 and the horizontal synchronization pulses 206 are shown in FIG. 2 using Manchester coding, other line codes may be used. Also, while the vertical synchronization pulse 204 is shown distinct from the horizontal synchronization pulses 206 by having a greater amplitude, other differences may or may not be used, such as a greater width, different line code, or different transmission frequency, in example embodiments.

While only one vertical synchronization pulse 204 and three horizontal synchronization pulses 206 are shown in FIG. 2, multiple vertical synchronization pulses 204 and horizontal synchronization pulses 206 may be received. A series of synchronization pulse data 203 corresponding to a single raster frame (which represents a single image) may include one vertical synchronization pulse 204, and a number of horizontal synchronization pulses 206, where the number of horizontal synchronization pulses can be greater than the number of raster lines in the image.

The vertical synchronization pulse 204 and the horizontal synchronization pulses 206 may be received at regular intervals, depending on a video format. For example, with a video format that has a frame rate of 60 Hz, the vertical synchronization pulses 204 may be received at a rate of 60 Hz, while the horizontal synchronization pulses 206 may be received at a rate of 60 Hz multiplied the number of lines in a frame, which can be greater than the number of lines in the image.

The video format may define a nominal timing relation between active video data 202 and the synchronization pulse data 203. For example, the video format may define a nominal time window 208 with reference to the synchronization pulse data 203 during which active video data should be displayed on the display device 106. The nominal time window 208 can be defined in relation to a synchronization pulse 204 or 206. For example, the nominal time window 208 can be defined to start a beginning time delay, T_{b}, after the synchronization pulse 204 or 2096 and to end at an ending time delay, Tₑ, after the synchronization pulse 204 or 206.

In the example shown in FIG. 2, the nominal time window 208, which corresponds to the time during which a raster line is to be displayed, is bounded by a window beginning 210 corresponding to the time T_{b} after HSync pulse 206 and by a window end 212 corresponding to the time Tₑ after HSync pulse 206. Thus, the window beginning 210 and the window end 212, which bound the nominal time window 208, are defined with reference to the synchronization pulse data 203 based on a beginning time delay and an ending time delay. Thus, the window beginning 210 may be determined by a beginning time delay from an edge of the horizontal synchronization pulse 206, and the window end 212 may be determined by an ending time delay from an edge of the horizontal synchronization pulse 206. The beginning time delay and the ending time delay may be determined based by the video format.

The number of active video data 202 values within each nominal time window 208 may be greater than those shown in FIG. 2. For example, if the raster frame corresponds to a video format with video images that are 640 pixels wide, 640 active video data 202 values may be included within each nominal time window 208.

In order to facilitate detecting the presence of active video data 202, the chip may calculate a noise threshold. The noise threshold may be calculated by, for example, computing an average amplitude of the noise 214. Noise 214 may be considered data which are received before or after the active video data 202.

The noise 214 may be measured during a blackout time window 216 during which time it is unlikely that any active video data 202 were received. The blackout time window 216 may be defined based in part on the synchronization pulse data 203 and video format. For example, a beginning and ending of the blackout time window 216 may be defined with reference to receipt of the synchronization pulse data 203.

In an example embodiment, a time delay between the beginning of a frame, such as when the vertical synchronization pulse 204 is received, and the first nominal time window 208, is much greater than a time delay between nominal time windows 208. In this example, which is shown in FIG. 2, the blackout time window 216 can be defined to be a time after receipt of the vertical synchronization pulse 204 at a time well before active video data 202 should be received during the first nominal time window 208, according to the video format. The time delay between the blackout time window 216 and the predicted receipt of active video data 202 may make it likely that any data received are noise 214 and not active video data 202.

In another example embodiment, the blackout time window 216 may be defined well after the last nominal time window 208 is defined within the frame according to the video format, but before the next frame. The defining of the blackout time window 216 well after the last nominal time window 208 makes it likely that any data received within the blackout time window 216 are noise 214.

While FIG. 2 shows active video data 202 which are included in a single frame, a plurality of frames or raster frames, such as three, may be transmitted simultaneously with the synchronization pulse data 203. For example, three raster frames, representing red, green, and blue contributions to the video image, may be transmitted simultaneously with the synchronization pulse data 203.

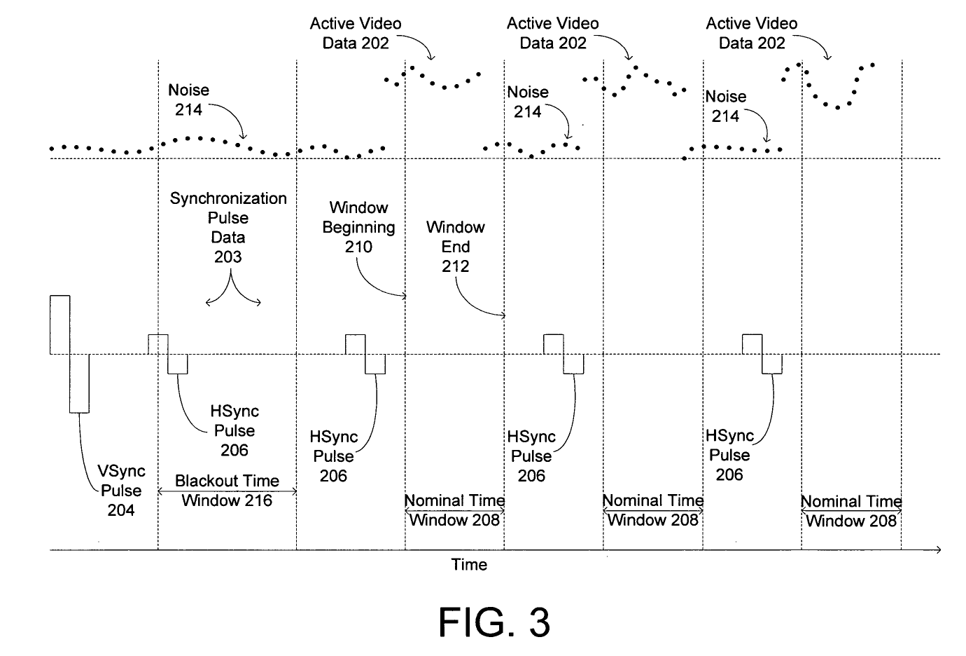

FIG. 3 is a timing diagram showing active video data 202 and synchronization pulse data 203, including the vertical synchronization pulse 204 and the horizontal synchronization pulses 206, in which the actual timing relation between the active video data 202 and the synchronization pulse data 203 deviates from the nominal timing relation. As shown in FIG. 3, some of the active video data 202 are received outside the nominal time windows 208, indicating that the actual timing relation between the active video data 202 and the synchronization pulse data 203 deviates from the nominal timing relation defined by the video format. In the example shown in FIG. 3, some of the active video data 202 are received before the nominal time windows 208, which may cause the image shown on the display 106 to be shifted left.

In another example, some of the active video data 202 could be received after the nominal time windows 208, causing the image shown on the display 106 to be shifted right. In yet another example, the active video data 202 could be received well before or after the first nominal time window 208, such as by a multiple of the time delay between horizontal synchronization pulses 206. In this latter example, the image shown on the display 106 would be shifted up or down by a number of lines equal to the multiple (of the time delay between horizontal synchronization pulses 206) by which the active video data 202 were received before or after the first nominal time window.

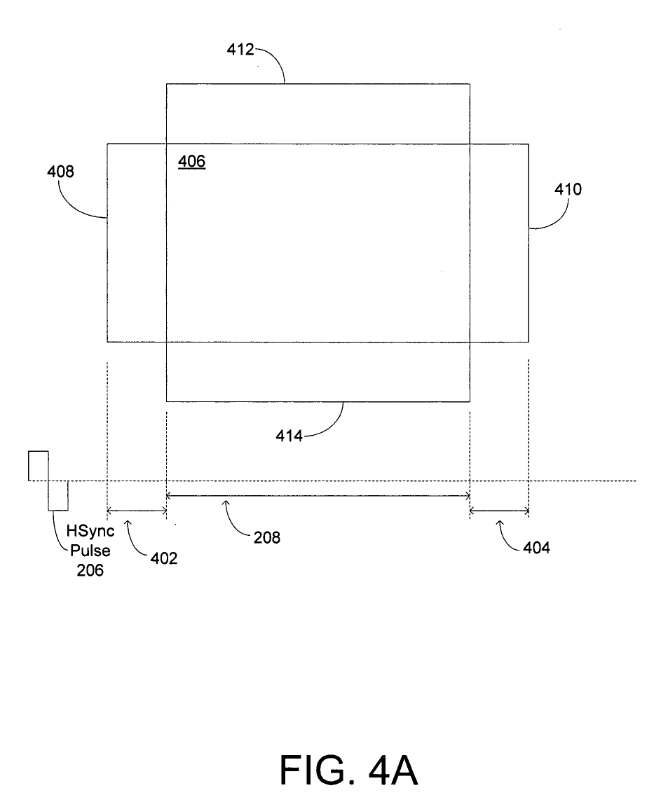

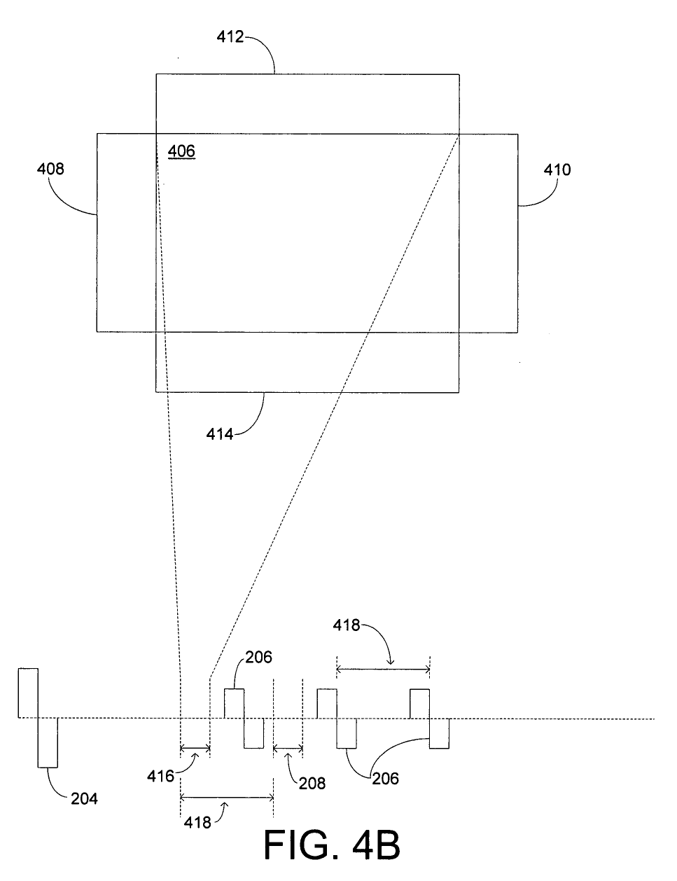

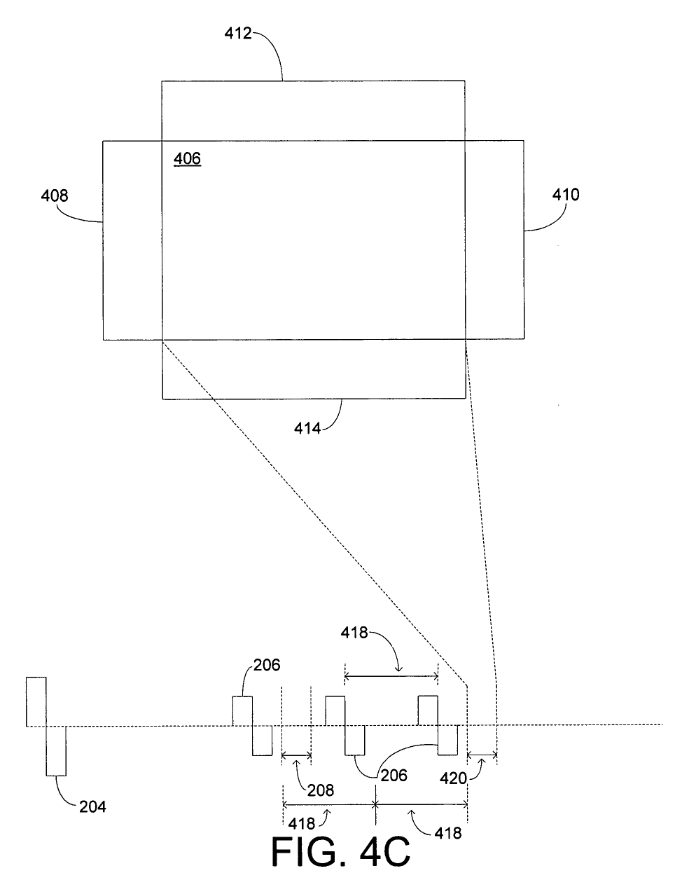

FIG. 4A shows a timing diagram with a left search region window 402 and a right search region window 404, along with a graphical representation of four search regions and a nominal active video region 406 of the display 106. FIG. 4A may not be drawn to scale. The nominal active video region 406 may correspond to the actual video image shown on the display 106 (shown in FIG. 1). The display 106 may show, in the nominal active video region 406, a video image generated from the active video data 202 values which were received within the nominal time windows 106.

The four search regions may include a left search region 408, a right search region 410, a top search region 412, and a bottom search region 414. The left search region 408 and the right search region 410 may include horizontal lines with a pixel length equal to a pixel width as defined by the video format. The pixel width may be equal to a ratio, such as one-tenth, of the pixel width (also known as the line length) of the nominal active video region 406. The number of horizontal lines in each of the left search region 408 and the right search region 410 may be equal to the pixel height of the nominal active video region 406. Thus, in the example of a 640 by 480 nominal active video region 406, each of the left search region 408 and right search region 410 may include 480 horizontal lines or rows which are each sixty-four pixels long.

The top search region 412 and the bottom search region 414 may include horizontal lines with a pixel length equal to a pixel width of the nominal active video region 406 defined by the video format; the number of horizontal lines in each of the top search region 412 and the bottom search region 414 may be equal to a ratio, such as one-tenth, of the pixel height of the nominal active video region 406. Thus, in the example of a 640 by 480 nominal active video region 406, each of the top search region 412 and bottom search region 414 may include forty-eight horizontal lines which are each 640 pixels long. While the width or height of each of the four search regions has been described as one-tenth of the nominal active video region 406, other ratios could be used as well.

At least one search region window corresponding to a search region may be defined by the video format. The search region window may be based on the synchronization pulse data 203 and a time delay factor, and may be outside of the nominal time window 208. In the example shown in FIG. 4A, a left search region window 402 may be defined with reference to the horizontal synchronization pulse 104. The left search region window 402 may include data received just before the nominal time window 208; in an example embodiment, there may be a one-pixel overlap between the left search region window 402 and the nominal time window 208.

A left search region window 402 may be defined for each nominal time window 208, and may have a length which is a ratio, such as one-tenth, of the length of the nominal time window 208; thus, for a video format defining a 640 by 480 image, 480 left search region windows 402 may be defined, with each left search region window 402 preceding a nominal time window 208 and having a length corresponding to the time required to transmit sixty-four pixel values. The dashed lines show the correspondence between data values received within the left search region window 402 and a horizontal row or line of the left search region 408.

A right search region window 404 corresponding to the right search region 410 may also be defined with reference to the synchronization pulse data 203 based on the video format. A right search region window 404 corresponding to the right search region 410 may include data received just after the nominal time window 208, for example. In the example of the video format defining the 640 by 480 video image, 480 right search region windows 404 may be defined, with each right search region window 404 following a nominal time window 208 and having a length corresponding to the time required to transmit sixty-four pixel values. The dashed lines show the correspondence between data values received within the right search region window 404 and a horizontal line or row of the right search region 410.

Search region windows corresponding to the top search region 412 and the bottom search region 414 may also be defined with reference to the synchronization pulse data 203 based on the video format. FIG. 4B shows a timing diagram with a top search region window 416, along with a graphical representation of the four search regions and the nominal active video region 406 of the display 106 (shown in FIG. 1). FIG. 4B may not be drawn to scale. The top search region window 416 may have a length or duration equal to that of the nominal time windows 208 or may have a length or duration equal to the time between successive HSync pulses 206. The dashed lines show the correspondence between data values received within the top search region window 416 and the horizontal line or row of the top search region 412.

The top search region windows 416 may be defined as occurring in multiples of horizontal line periods 418 before the first nominal time window 208 of a frame. Horizontal line periods 418 may be defined as the time difference between successive horizontal synchronization pulses 206. In the example of the 640 by 480 video image, forty-eight top search region windows 416 may be defined, with each of the top search region windows 416 having a length equal to the length of the nominal time windows 208 or having a length or duration equal to the time between successive HSync pulses 206. In the example in which the top search region 412 overlaps with the nominal active video region 406 by one pixel, the last top search region window 418 in a frame may be identical to the first nominal time window 208 in the frame.

FIG. 4C shows a timing diagram with a bottom search region window 420, along with a graphical representation of the four search regions and the nominal active video region 406 of the display 106 (shown in FIG. 1). FIG. 4C may not be drawn to scale. The bottom search region window 420 may have a length or duration equal to that of the nominal time window 208 or having a length or duration equal to the time between successive HSync pulses 206. The dashed lines show the correspondence between the data values received within the bottom search region window 420 and the horizontal lines or rows of the bottom search region 414.

The bottom search region windows 420 may be defined as occurring in multiples of horizontal line periods 418 after the first nominal time window 208 of a frame. In the example of the 640 by 480 pixel video image, forty-eight bottom search region windows 420 may be defined, with each of the bottom search region windows 420 having a length equal to the length of the nominal time windows 208. In the example in which the bottom search region 414 overlaps with the nominal active video region 406 by one pixel, the first bottom search region window 420 in a frame may be identical to the last nominal time window 208 in the frame.

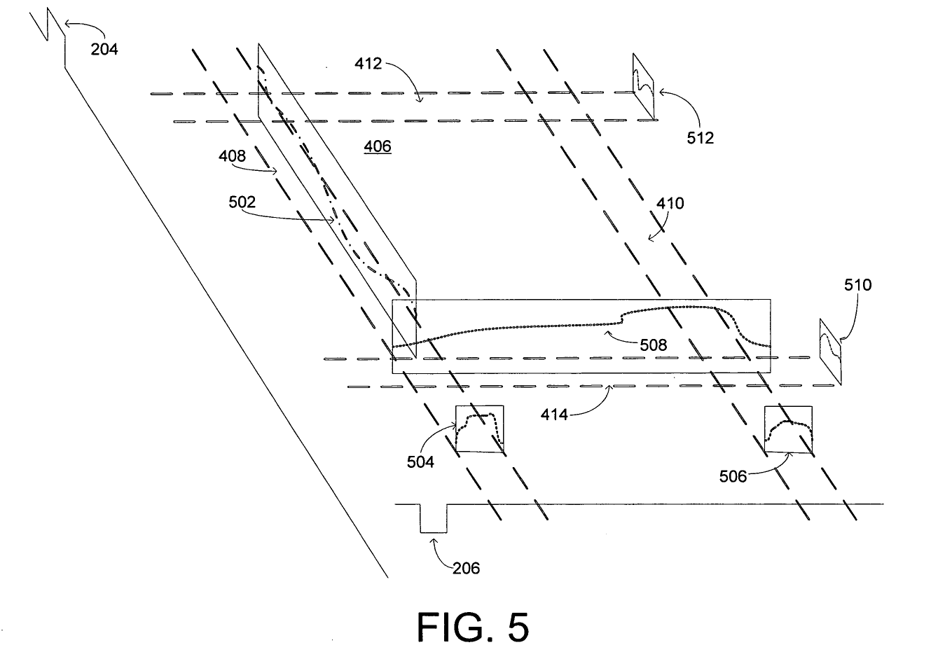

FIG. 5 shows a graphical representation of the four search regions of the display, along with pixel values for a vertical line within the left search region 408, pixel values for a horizontal line within the bottom search region 414, and line signal amplitude values for the left search region 408, right search region 410, top search region 412, and bottom search region 414. The four pairs of dashed lines show the boundaries for the left search region 408, right search region 410, top search region 412, and bottom search region 414. FIG. 5 may not be drawn to scale.

A vertical line pixel function 502 within the left search region 408 may represent successive pixel values corresponding to pixels in a vertical line within the left search region 408. The pixel values in the vertical line pixel function 502 may be representations of active video data points 202 received at substantially identical times after an HSync pulse 206 and before successive nominal time windows 208. Referring back to FIG. 4A, the pixel values in the vertical line pixel function may represent active video data points 202 received at the same time within successive left search region windows 402.

Multiple vertical line pixel functions 502 may exist within the left search region 408. Each vertical line pixel function 502 may represent active video data points 202 received at a different time within the successive left search region windows 402. The number of vertical line pixel functions 502 within the left search region 408 may be equal to the pixel width of the left search region 408, which may also be equal to the number of data values received in each left search region window 402. In the example in which the left search region 408 is sixty-four pixels wide and 480 pixels high, the left search region 408 may include sixty-four vertical line pixel functions 502, with each vertical line pixel function 502 including 480 data values.

A left line signal amplitude function 504 may include data points representing average values of successive vertical line pixel functions 502 within the left search region 408. An average value of each of the vertical line pixel functions 502 may be determined, and each of these average values may become a data point within the left line signal amplitude function 504. The left line signal amplitude function 504 may thereby represent an average of data values from each of the left search region windows 402 preceding the nominal time windows 208 for a given frame. In the example in which the left search region 408 is sixty-four pixels wide and 480 pixels high, the left line signal amplitude function 504 may include sixty-four data points, each data point being an average of the 480 data values of the corresponding vertical line pixel function 502.

A right line signal amplitude function 506 may be determined in a similar manner to the left line signal amplitude function 504, with the data points being averaged and subsequently squared from vertical line pixel functions (not shown) in the right search region 410. The right line signal amplitude function 506 may thereby represent an average of data values from each of the right search region windows 404 which follow the nominal time windows 208 for a given frame.

A horizontal line pixel function 508 within the bottom search region 414 may represent successive pixel values corresponding to pixels in a horizontal line within the bottom search region 414. The pixel values in the horizontal line pixel function 508 may be representations of active video data points 202 received within a single bottom search region window 420 (shown in FIG. 4C).

Multiple horizontal line pixel functions 508 may exist within the bottom search region 414. Successive horizontal line pixel functions 508 may represent active video data points 202 received within successive bottom search region windows 420. Each successive bottom search region window 420 may be received a horizontal line period 418 (shown in FIG. 4C) after the previous bottom search region window 420. The number of horizontal line pixel functions 508 within the bottom search region 414 may be equal to the pixel height of the bottom search region 414, which may also be equal to the number of bottom search region windows 420, which in turn may be a specified ratio, such as one-tenth, of the number of nominal time windows 208 (shown in FIG. 2). In the example in which the bottom search region 414 is 640 pixels wide and forty-eight pixels high, the bottom search region 414 may include forty-eight horizontal line pixel functions 508, with each horizontal line pixel function 508 including 640 data values.

A bottom line signal amplitude function 510 may include data points representing average values of successive horizontal line pixel functions 508 within the bottom search region 414. An average value of each of the horizontal line pixel functions 508 may be determined, and each of these average values may become a data point within the bottom line signal amplitude function 510. Each data point in the bottom line signal amplitude function 510 may thereby represent a squared average of the data values within a bottom search region window 420. The bottom line signal amplitude function 510 may thereby represent squared average values for each of the bottom search region windows 420 corresponding to a given frame. In the example in which the bottom search region 414 is 640 pixels wide and forty-eight pixels high, the bottom line signal amplitude function 510 may include forty-eight data points, each data point being an average of the 640 data values of the corresponding horizontal line pixel function 508, said horizontal line pixel function 508 being a representation of a bottom search region window 420.

A top line signal amplitude function 512 may be determined in a similar manner to the bottom line signal amplitude function 510, with the data points being averaged and subsequently squared from horizontal line pixel functions (not shown) in the top search region 412. Each successive data point in the top line signal amplitude function 512 may thereby represent an average of a successive top search region window 416 which precedes the nominal time windows 208 corresponding to a given frame, the successive top search region windows 416 having a time delay between them substantially equal to the horizontal line period 418 (shown in FIG. 4B).

The line signal amplitude functions 504, 506, 512, 510 may represent line signal amplitudes for lines within each of the search regions 408, 410, 412, 414. These line signal amplitudes may represent averaged and subsequently squared values of the active video data 202 at predetermined points within a frame of the video signal, the predetermined points being based in part on the video format.

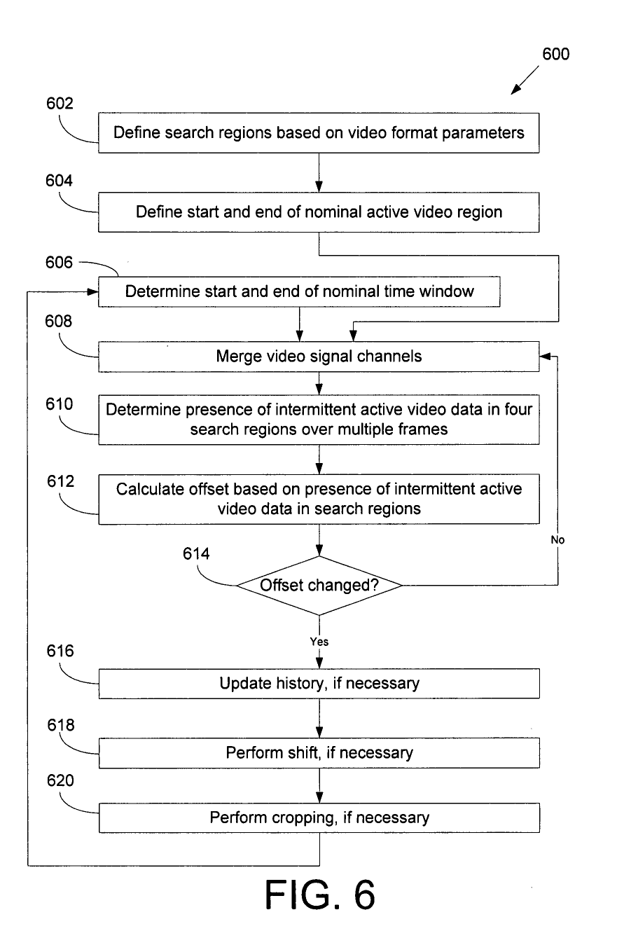

FIG. 6 is a flowchart showing a method 600 of correcting timing errors according to an example embodiment. The method 600 may be performed by the chip 104 shown in FIG. 1, for example. Upon receipt of synchronization pulse data 203, the chip 104 may define search regions based on video format parameters (602), for example. The video format parameters may define a pixel width and pixel height of a video image, and a frequency of receiving frames, such as raster frames, and may define a nominal timing relation between active video data 202 and synchronization pulse data 203, such as the vertical synchronization pulses 204 and the horizontal synchronization pulses 206. The chip 104 may define a left search region window 402, a right search region window 404, a top search region window 416, and a bottom search region window 420, with reference to the synchronization pulse data 203 based on the video format parameters.

The method 600 may proceed to defining a start and an end of a nominal active video region 406 (604) based on the video format parameters. The start and end of the nominal active video region 406 may correspond to the window beginning 210 and the window end 212 discussed with reference to FIG. 2, and the nominal active video region 406 may correspond to the nominal time windows 208. The chip 104 may also define a blackout time window 216 with reference to the synchronization pulse data 203 where it is expected that no active video data 202 will be received.

The method 600 may proceed to merging video signal channels (608), if the video signal includes a plurality of video signal channels. For example, if the video signal includes a red, green, and blue channel (or a cyan, yellow, and magenta channel), the amplitude of the signals at a particular time can be added or averaged. Merging the video signal channels may reduce the information to be processed and lead to more results that do not depend on the color of the video image. The chip 104 may determine an average of component data values from the video signal channels, or may select the highest component data values from the video signal channels. For example, if the chip 104 received three video signal channels, the chip 104 may average the three components, or may select the highest component. In the examples where the three video signal channels are sent along three different wires or are frequency division multiplexed, the three component data values may be received at substantially identical times, the times corresponding to pixel time slots defined by the video format with reference to the synchronization pulse data 203. The chip 104 may average the three component data values received during each pixel time slot, or may select the highest component data value received during each pixel time slot.

The method 600 may proceed to determining the presence of active video data 202 in the four search regions over multiple frames (610), according to an example embodiment. The chip 104 may, for each frame, generate a left line signal amplitude function 504 corresponding to the left search region 408, a right line signal amplitude function 506 corresponding to the right search region 410, a top line signal amplitude 512 corresponding to the top search region 412, and a bottom line signal amplitude function 510 corresponding to the bottom search region 414, according to an example embodiment. These line signal amplitude functions 504, 506, 512, 510 may be generated for successive frames, or the frames for which the line signal amplitude functions 504, 506, 512, 510 are generated may be generated less frequently, e.g., every third frame, every fifth frame, etc. Each of the line signal amplitude functions 504, 506, 512, 510 may be based on a running average over several successive frames to generate time-averaged line signal amplitudes, which may reduce the effect of shot noise or bursts.

The comparator 122 may compare the time-averaged and subsequently squared line signal amplitudes to the noise threshold. If a time-averaged and subsequently squared line signal amplitude(s) exceeds the noise threshold by a certain amount, then active video data 202 may be considered to be present in the search region(s) 408, 410, 412, 414 corresponding to the time-averaged and subsequently squared line signal(s) for which the amplitude(s) exceeds the noise threshold. If the time-averaged line signal amplitude(s) does not exceed the noise threshold, then the data received in the search region window(s) 402, 404, 416, 420 may be considered to be noise, such that a conclusion may be drawn that active video signal does not exist in the search region window.

If the comparator 122 of the chip 104 has determined the presence of active video data 202 in any of the four search regions 408, 410, 412, 414, then the chip 104 may calculate an offset value or correction factor by which the timing relation between the synchronization pulse signal and the active video signal must be adjusted so that the video image is correctly positioned on the output portion of the display device 106. The offset is used to correct a timing relation between the active video signal and the synchronization pulse signal that is output from the graphics co-processor 114 that does not correspond to the nominal timing relation between the two signals defined by the video format.

The comparator 122 of the chip 104 may calculate the offset by determining the data value within the time-averaged and subsequently squared line signal amplitude(s) which is farthest from the nominal active video region 406. For example, with a time-averaged and subsequently squared line signal amplitude determined based on left line signal amplitude functions 502 or right line signal amplitude functions 506 from multiple frames, the data value corresponding to pixel time slots farthest from the nominal time windows 208 which exceeds the noise threshold may be used to determine the left or right offset, respectively. In this example, the left or right offset may be the number of pixel time slots before or after the nominal time windows 208 during which the active video data was received. In the example in which the search regions 408, 410, 412, 414 overlap with the nominal active video region 406 by one pixel, the left or right offset may be the number of pixel time slots, plus one, before or after the nominal time windows 208 during which the data value was received.

In another example, with a time-averaged and subsequently squared line signal amplitude determined based on bottom line signal functions 510 from multiple frames, the data value corresponding to the bottom search region window 414 farthest from the last nominal time window 208 which exceeds the noise threshold may be used to determine the bottom offset. In this example, the bottom offset may be the number of horizontal time periods 418 after the last nominal time window 208 during which the active video data were received in the bottom search region window 420.

In yet another example, with a time-averaged and subsequently squared line signal amplitude determined based on top line signal functions 512 from multiple frames, the data value corresponding to the top search region window 412 which is farthest from the first nominal time window 208 which exceeds the noise threshold may be used to determine the top offset. In this example, the top offset may be the number of horizontal time periods 418 before the first nominal time window 208 during which the active video data were received in the top search region window 416.

The comparator 122 of the chip 104 may proceed from calculating the offset (612) to determining whether the offset should be changed (614). The chip 104 may determine whether the offset should be changed based on whether the offset, and hence the deviation of the actual timing relation from the nominal timing relation, exceeds a tolerance value. In the example in which the search regions 408, 410, 412, 414 overlap the nominal active video region 406 by one pixel, the tolerance value for the offset may be one pixel. Adjustments of the offset, and hence the actual timing relation, may cause the actual timing relation, and hence the offset, to fall within the tolerance value.

In an example embodiment, comparator 122 may also determine whether the offset should be changed by consulting a register 128 for past adjustments of the actual timing relation between the active video data 202 and the synchronization pulse data 203 based on past offset detections. The chip 104 may determine that the offset should be changed if there has not been a previous change in the actual timing relation based on an offset equal to or greater than the current offset. For example, if the chip 104 determines that the left offset is ten pixels, and the register 128 indicates that the chip 104 has previously adjusted the actual timing relation based on a left offset of ten or more pixels, then the chip 104 may determine not to change the offset.

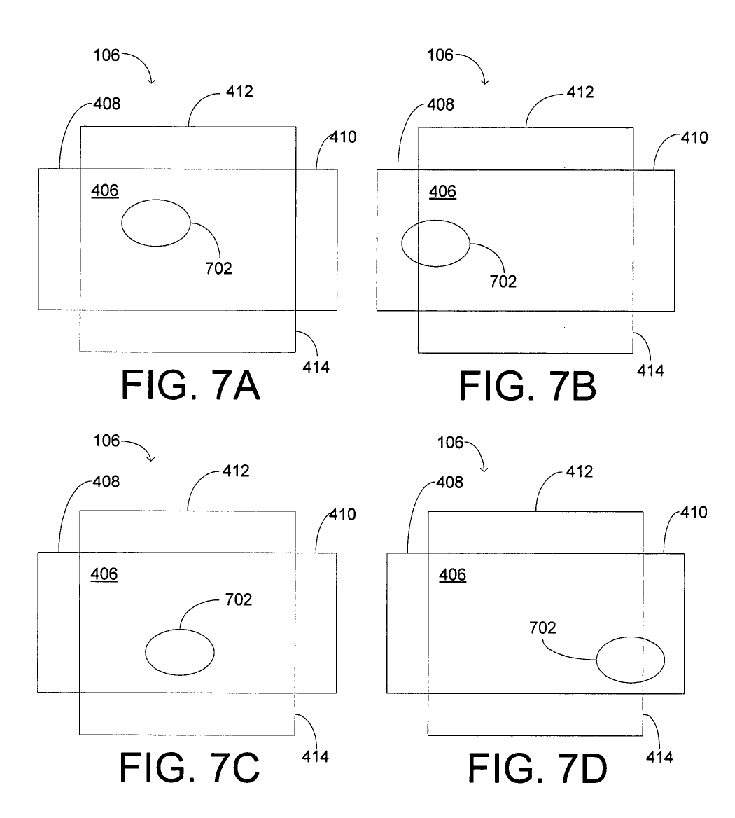

The comparator 122 may also determine not to change the offset or adjust the actual timing relation between the synchronization signals and the active video signal upon consulting the register 128 and determining that an actual line length included in the video signal exceeds a nominal line length defined by the video format. This determination not to change the offset or adjust the actual timing relation may be based on a previous offset in the opposite direction, indicating that the width or height of the lines included in the video signal may be longer than the nominal active video region 406. FIGS. 7A through 7D may be helpful in understanding this process.

FIGS. 7A through 7D show the display 106 with the four search regions 408, 410, 412, 414 and a video object 702 moving against the background into and out of the search regions. The video object 702 moving against the background may, for example, be part of a screensaver function. In FIG. 7A, the object 702 is located entirely in the nominal active video region 406. Active video data 202 are received for the portion of the nominal active video region 406 corresponding to the object 702, but not for the portion of the nominal active video region 406 outside the object 702 or for any of the four search regions 408, 410, 412, 414. The object 702 may be colored on the display 104 according to pixel data values for the three color channels, for example. Because no active video data 202 are received for the portion of the nominal active video region outside the object 702, the area of the display 106 outside the object 702 may be colored the background color.

FIG. 7B shows an example in which part of the object 702 moved into the left search region 408. The chip 104 may determine a left offset based on the presence of active video data in the left search region 408. In this example, there is no history of previous offsets, so the chip 104 may adjust the actual timing relation between the active video data 202 and the synchronization pulse data 203. The actual timing relation may be adjusted to shift the video image to the right, causing the object 702 to appear entirely within the nominal active video region 406.

FIG. 7C shows an example in which the object 702 is fully within the nominal active video region 406. In this example, the present offset values for all four search regions 408, 410, 412, 414 may be zero. However, the chip 104 may maintain the offset based on the presence of the object 702 in the left search region 408 in the example shown in FIG. 7B. Thus, the object 702 may be shifted right from where it would appear without any offset correction.

FIG. 7D shows an example in which the object 702 has drifted partially into the right search region 410. In this example, the chip 104 may determine a right offset based on the presence of active video data 202 in the right search region. However, the chip 104 may consult the register 128 and determine that there has previously been a left offset. Based on the current left offset and the present right offset, the chip 104 may determine that an actual line length included in the video signal exceeds the nominal line length defined by the video format, and determine either not to adjust the actual timing relation, or to adjust the actual timing relation back to the original timing relation that existed before FIG. 7B. Instead of shifting the video image to include the object 702, the image may be cropped, making less than all of the object 702 visible.

Returning to the example method 600 shown in FIG. 6, if the chip 104 determines not to change the offset, such as based on a lack of active video data 202 in any of the search regions 408, 410, 412, 414, or based on consulting the register 128 for past offsets, then the method may return to merging video signal channels (608).

If the chip 104 does determine to change the offset, then the method may proceed to updating the history, if necessary (616). The chip 104 may, for example, store the fact of offset or adjustment in the register 128, or may store a magnitude and direction of the offset or adjustment in the register 128.

The method 600 may proceed from updating the history (616) to performing a shift, if necessary (618). The shift may be based on the offset. The chip 104 may, for example, determine to adjust the timing relation to shift the image to the right if there is a left offset value but not a right offset value, adjust the timing relation to shift the image to the left if there is a right offset value but not a left offset value, shift the image down if there is a top offset value but not a bottom offset value, or shift the image up if there is a bottom offset value but not a top offset value. In these examples, the chip 104 may adjust the timing relation to shift the image by a number of pixels equal to the offset value, for example.

The method 600 may proceed from performing the shift, if necessary (618), to performing cropping, if necessary (620). Cropping may be performed if there is both a left offset and a right offset, or if there is both a top offset and a bottom offset, for example. In cropping, part of the image outside the nominal active video region 406 may not be displayed. Cropping may also involve shifting. The shift value for a shift/crop operation may be equal to half of a distance in the offset values. For example, if the left offset value is ten pixels and the right offset value is six pixels, then the actual timing relation may be adjusted to shift the image right by two pixels. If the difference between the offset values is an odd number, then the shift value may be rounded either up or down after the division.

The method 600 may proceed from performing cropping (620) to determining a start and end of the nominal time window 208 (606). Adjusting the actual timing relation may include adjusting the nominal time window 208 by adjusting the window beginning 210 and the window end 212. Adjusting the nominal time window 208 may in turn move the search regions 408, 410, 412, 414. The method may proceed from determining the start and end of the nominal time window 208 (606) back to merging the video signals (608), according to an example embodiment.

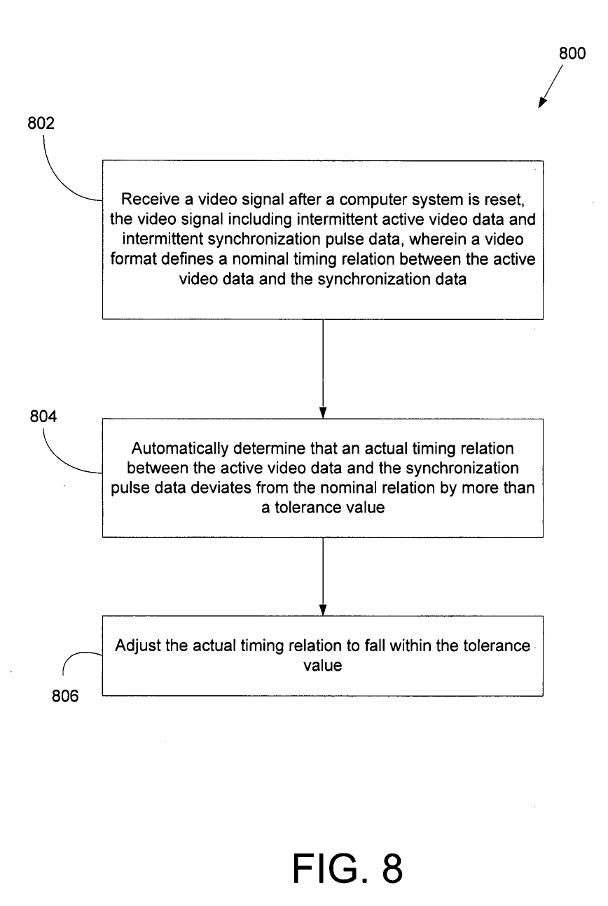

FIG. 8 is a flowchart showing another method 800 according to another example embodiment. The method 800 may be performed periodically, according to an example embodiment. This example method 800 may include receiving a video signal at a certain amount of time after a computer system is reset (e.g., five minutes after a computer system is reset, ten minutes after a computer system is reset, 15 minutes after a computer system is reset, or 30 minutes after a computer system is reset). In any event the method 800 is not triggered by the resetting of the computer system. The video signal may include active video data 202 and synchronization pulse data 203. A video format may define a nominal timing relation between the active video data 202 and the synchronization pulse data 202 (802). The video signal may be received at any time during operation of the computer system, and the method 800 may not be limited to operation when the computer system is restarted or a user requests realignment of the video image, for example.

The method 800 may also include automatically, or without user intervention, determining that an actual timing relation between the active video data 202 and the synchronization pulse data 203 deviates from the nominal relation by more than a tolerance value (804). This determination may be made, for example, by comparing the data values in the line signal amplitude functions 504, 506, 510, 512, or the time-averaged and subsequently squared line signal amplitude functions, to the noise threshold.

The method 800 may also include adjusting the actual timing relation to fall within the tolerance value (806). The adjustment to the actual timing relation may include adjusting the nominal time windows 208, and may be based on offset values calculated by comparing the data values in the line signal amplitude functions 504, 506, 510, 512, or the time-averaging and squaring of line signal amplitude functions, to the noise threshold, for example.

In an example embodiment, defining the nominal timing relation may be associated with defining a nominal time window 208 of the video signal with reference to the synchronization pulse data 203 based on a beginning time delay and an ending time delay. In this example, the beginning time delay and the ending time delay may be determined by the video format. Also in this example, adjusting the actual timing relation may be associated with adjusting at least one of the beginning time delay and the ending time delay.

In another example, which may include shifting the video image but not cropping the video image, the method 800 may include determining a duration exceeding the tolerance value by which the active video data 202 are received either before or after, but not both before and after, the nominal time window 208. The duration may correspond to an offset value. In this example, the method 800 may also include shifting the nominal time window 208 by adding a shift value to both the beginning time delay and the ending time delay. The shift value may be substantially equal to a time by which the duration exceeds the tolerance value, for example. The shift value may be calculated based on the offset value, in an example embodiment.

In another example, which may include cropping the video image, the method 800 may include a first duration exceeding the tolerance value and a second duration exceeding the tolerance value by which the active video data 202 were received before and after the nominal time window 208, respectively. The first duration and the second duration may correspond to offset values for search regions 408, 410, 412, 414 on opposite sides of the nominal active video region 406. For example, the first duration and the second duration may correspond to offset values for the left search region 408 and the right search region 410, or may correspond to offset values for the top search region 412 and the bottom search region 414. In this example, the method 800 may include adding a shift value to both the beginning time delay and the ending time delay. The shift value may be substantially equal to half of a difference between the first duration and second duration, for example.

The method 800 may also include determining a line signal amplitude by averaging values of the active video data 202 at predetermined points within a frame of the video signal. The predetermined points may be based in part on the video format. For example, the line signal amplitude may be determined by averaging values of the active video data 202 which are each received a specified time before or after the nominal time window 208. In another example, the line signal amplitude may be determined by averaging values of the active video data 202 which are received during a top search region window 416 or a bottom search region window 420. According to another example, a time-averaged line signal amplitude may be determined by averaging values of the active video data at predetermined points within multiple frames of the video signal.

In another example embodiment, the method 800 may include averaging video data values by averaging three component data values of the active video data 202 from three component channels. The three component data values may be received at substantially identical times. For example, the chip 104 may receive active video data 202 for three different colors through three component channels. The chip 104 may average the data values received at substantially identical times to reduce the information to be processed in determining the presence of active video data 202 in the search regions 408, 410, 412, 414.

In another example embodiment, the method 800 may include determining a noise threshold based on measuring a portion of the video signal received during a blackout time window 216 defined with reference to receipt of the synchronization pulse data 203. The blackout time window 216 may be based in part on the synchronization pulse data 203 and the video format. The noise threshold may be based on an average of the data values received within the blackout time window 216, for example.

In another example embodiment, the method 800 may include consulting a measurement for past adjustments of the actual timing relation to determine an actual line length included in the video signal. The past adjustments may include shift values, and the register 128 may be configured to store past shift values or past adjustments of the actual timing relation. The method 800 may also include storing the adjusting in the register 128, or storing a magnitude and direction of the adjustment in the register 128.

The method 800 may also include subsequently consulting the register 128, determining that an actual length included in the video signal exceeds a nominal line length defined by the video format based on the consulting, and determining not to adjust the actual timing relation based on the determination of the actual line length. For example, the history of adjustments or offsets may indicate that the video signal is transmitting raster frames with a pixel width or height longer than the nominal active video region 406 may accommodate. In this example, instead of determining to shift the video image, the chip 104 may determine to crop the video image.

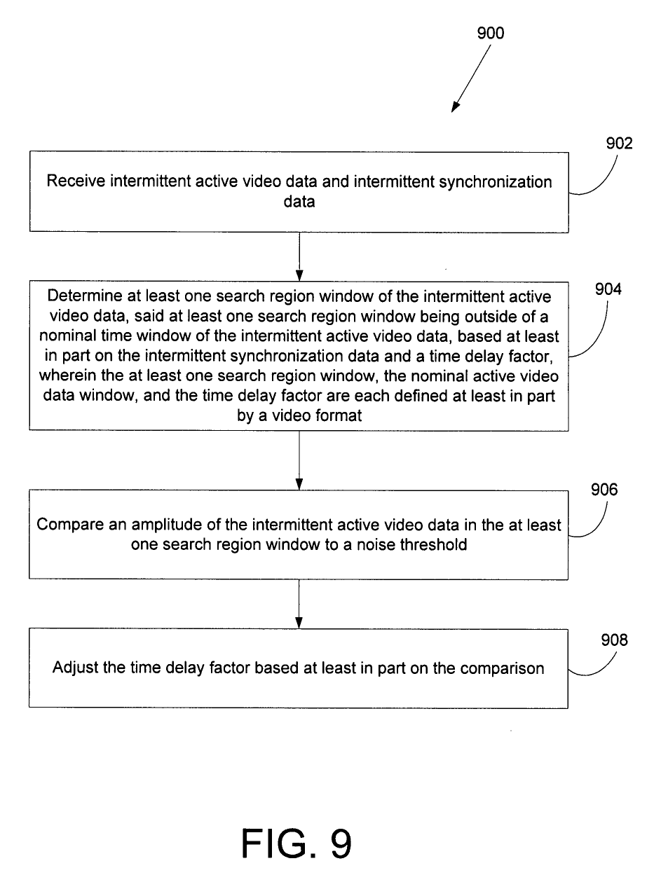

FIG. 9 is a flowchart showing another method 900 according to another example embodiment. This example method 900 may include receiving active video data 202 and synchronization data 203 (902).

The method 900 may also include determining at least one search region window 402, 404, 416, 420 of the active video data 202 based at least in part on the synchronization data 203 and a time delay factor. The at least one search region window 402, 404, 416, 420 may be outside of a nominal time window 208 of the active video data 202. The at least one search region window 402, 404, 416, 420, the nominal time window 208, and the time delay factor may each be defined at least in part by a video format (904).

The method 900 may also include comparing an amplitude of the active video data 202 in the at least one search region window 402, 404, 416, 420 to a noise threshold (906). The noise threshold may be determined, for example, by averaging data values received within a blackout time window 216. The blackout time window 216 may be defined by the video format with reference to the synchronization pulse data 203, and may be defined to make it unlikely that any active video data 202 will be received during the blackout time window 216. Comparing the amplitude of the active video data 202 in the at least one search region window 402, 404, 416, 420 to the noise threshold may result in a determination that active video data 202 are being received in the at least one search region window 402, 404, 416, 420, and that an actual timing relation between the active video data 202 and the synchronization pulse data 203 may be deviating from a nominal timing relation.

The method 900 may also include adjusting the time delay factor based at least in part on the comparison (908). Adjusting the time delay factor may cause the actual timing relation to conform to the nominal timing relation.

In an example embodiment, the method 900 may include determining the amplitude of the active video data 202 by averaging three component values of the active video data 202, the component values including values corresponding to a first color, a second color, and a third color. The first color, second color, and third color may, for example, be red, green, and blue.

In another example embodiment, the method 900 may include comparing a signal strength of each of a plurality of lines of a raster frame to the noise threshold. The raster frame may be included in the active video data 202. Each of the plurality of lines may be included within the at least one search region window 402, 404, 416, 420.

The method 900 may also include comparing a signal strength of each of a plurality of lines included within the at least one search region window 402, 404, 416, 420 to a noise threshold and adjusting the time delay factor based at least in further part on a number of the plurality of lines which have signal strengths exceeding the noise threshold, according to an example embodiment. The number of the plurality of lines may correspond to an offset value within a search region 408, 410, 412, 414.

The method 900 may also include comparing at least two signal strengths of at least two pluralities of lines included in at least two search regions 408, 410, 412, 414 defined as corresponding to opposite sides of the active video portion. For example, the pluralities of lines may be included in the left search region 408 and right search region 410, and/or the top search region 412 and the bottom search region 414. This example may include adjusting the time factor, or shifting the image, if one of the at least two signal strengths exceeds the noise threshold, and cropping the active video portion if two of the at least two signal strengths exceed the noise threshold.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method comprising:
receiving a video signal after a computer system is reset, the video signal including active video data and synchronization pulse data, wherein a video format defines a nominal timing relation between the active video data and the synchronization pulse data;
automatically determining that an actual timing relation between the active video data and the synchronization pulse data deviates from the nominal relation by more than a tolerance value; and
adjusting the actual timing relation to fall within the tolerance value.

2. The method of claim 1, wherein receiving the video signal after the computer system is reset includes receiving the video signal more than ten minutes after the computer system is reset.

3. The method of claim 1, further comprising:
defining a nominal time window of the video signal with reference to the synchronization pulse data based on a beginning time delay and an ending time delay, the beginning time delay and the ending time delay being determined by the video format; and
adjusting at least one of the beginning time delay and the ending time delay.

4. The method of claim 1, further comprising:
defining a nominal time window of the video signal with reference to the synchronization pulse data based on a beginning time delay and an ending time delay, the beginning time delay and the ending time delay being determined by the video format;
determining a duration exceeding the tolerance value by which the active video data are received either before or after, but not both before and after, the nominal time window; and
adding a shift value to both the beginning time delay and the ending time delay, the shift value being substantially equal to a time by which the duration exceeds the tolerance value.

5. The method of claim 1, further comprising:
defining a nominal time window of the video signal with reference to the synchronization pulse data based on a beginning time delay and an ending time delay, the beginning time delay and the ending time delay being determined by the video format;
determining a first duration exceeding the tolerance value and a second duration exceeding the tolerance value by which the active video data were received before and after the nominal time window, respectively; and
adding a shift value to both the beginning time delay and the ending time delay, the shift value being substantially equal to half of a difference between the first duration and the second duration.

6. The method of claim 1, further comprising averaging values of the active video data at predetermined points within a frame of the video signal to determine a line signal amplitude, the predetermined points being based in part on the video format.

7. The method of claim 1, further comprising averaging values of the active video data at predetermined points within multiple frames of the video signal to determine a time-averaged and subsequently squared line signal amplitude, the predetermined points being based in part on the video format.

8. The method of claim 1, further comprising determining average video data values by averaging three component data values of the active video data from three component channels, the three component data values being received at substantially identical times.

9. The method of claim 1, further comprising determining a noise threshold based on measuring a portion of the video signal received during a blackout time window defined with reference to receipt of the synchronization pulse data, the blackout time window being based in part on the synchronization pulse data and video format.

10. The method of claim 1, further comprising:
consulting a register for past adjustments of the actual timing relation to determine an actual line length included in the video signal; and
storing the adjusting in the register.

11. The method of claim 1, further comprising:
consulting a register configured to store past adjustments of the actual timing relation to determine an actual line length included in the video signal; and
storing a magnitude and direction of the adjustment in the register.

12. The method of claim 1, further comprising:
storing a magnitude and a direction of a first adjustment of the actual timing relation in a register; and
subsequently consulting the register, determining that an actual line length included in the video signal exceeds a nominal line length defined by the video format based on the consulting, and determining not to adjust the actual timing relation based on the determination of the actual line length.

13. The method of claim 1, wherein the method is performed periodically.

14. A method comprising:
receiving active video data and synchronization data;
determining at least one search region window of the active video data, said at least one search region window being outside of a nominal time window of the active video data, based at least in part on the synchronization data and a time delay factor, wherein the at least one search region window, the nominal active video data window, and the time delay factor are each defined at least in part by a video format;
comparing an amplitude of the active video data in the at least one search region window to a noise threshold; and
adjusting the time delay factor based at least in part on the comparison.

15. The method of claim 14, further comprising determining the amplitude of the active video data by averaging component values of the active video data, the component values including values corresponding to a first color, a second color, and a third color.

16. The method of claim 14, further comprising comparing a signal strength of each of a plurality of lines of a raster frame to the noise threshold, the raster frame being included in the active video data, wherein the each of the plurality of lines are included within the at least one search region window.

17. The method of claim 14, further comprising:
comparing a signal strength of each of a plurality of lines included within the at least one search region window to the noise threshold; and
adjusting the time delay factor based at least in further part on a number of the plurality of lines which have signal strengths exceeding the noise threshold.

18. The method of claim 14, further comprising:
comparing at least two signal strengths of at least two pluralities of lines included in at least two search regions defined as corresponding to opposite sides of the active video portion;
adjusting the time delay factor if one of the at least two signal strengths exceeds the noise threshold; and
cropping the active video portion if two of the at least two signal strengths exceed the noise threshold.

19. An apparatus comprising:
a video signal input port configured to receive an active video input signal for generating frames of an image on a display device;
a synchronization pulse input port configured to receive a synchronization pulse input signal for controlling the position of the image on the display device;
a clock signal generator configured to generate a clock signal;
a comparator configured to receive the video input signal, the synchronization pulse input signal, and the clock signal, and further configured to:
determine at least one search region window based on a video format and the synchronization pulse input signal; and
determine a timing error based on active video input data included in the active video input signal being received within the at least one search region window;
a delay block configured to delay the video input signal relative to the synchronization pulse input signal based on the timing error; and
an output block configured to output the delayed video signal for display on the display device.

20. The apparatus of claim 19, wherein the comparator is configured to receive the active video input signal, the synchronization pulse input signal, and the clock signal more than ten minutes after a computer system associated with the apparatus is reset, and the comparator is further configured to determine the at least one search region window based on the video format and the synchronization pulse input signal received more than ten minutes after the computer system was reset.

21. The apparatus of claim 19, wherein the comparator is configured to:
determine the at least one search region window based on the video format and the synchronization pulse input signal by defining a nominal time window of the active video input signal with reference to the synchronization pulse input signal based on a beginning time delay and an ending time delay, the beginning time delay and the ending time delay being determined by the video format; and
determine the timing error based on the active video input data included in the active video input signal being received within the at least one search region window by determining a first duration exceeding a tolerance value and a second duration exceeding the tolerance value by which the active video input data were received before and after the nominal time window, respectively; and
wherein the delay block is configured to delay the video input signal relative to the synchronization pulse input signal based on the timing error by adding a shift value to both the beginning time delay and the ending time delay, the shift value being substantially equal to half of a difference between the first duration and the second duration.

22. The apparatus of claim 19, wherein the comparator is configured to:
average values of the active video input data at predetermined points within a frame of the active video input signal to determine a line signal amplitude, the predetermined points being based in part on the video format;
determine the at least one search region window based on the video format and the synchronization pulse input signal; and
determine the timing error based on the line signal amplitude within the at least one search region window.

23. The apparatus of claim 19, wherein the comparator is configured to:
average values of the active video input data at predetermined points within multiple frames of the active video input signal to determine a time-averaged and subsequently squared line signal amplitude, the predetermined points being based in part on the video format;
determine the at least one search region window based on the video format and the synchronization pulse input signal; and
determine the timing error based on the time-averaged and subsequently squared line signal amplitude within the at least one search region window.

24. The apparatus of claim 19, wherein the comparator is configured to:
determine average video data values by averaging three component data values of the active video input data from three component channels, the three component data values being received at substantially identical times;
determine the at least one search region window based on the video format and the synchronization pulse input signal; and
determine the timing error based on the averaged video data values within the at least one search region window.

25. The apparatus of claim 19, wherein the comparator is further configured to determine a noise threshold based on measuring a portion of the video signal received during a blackout time window defined with reference to receipt of the synchronization pulse input signal, the blackout time window being based in part on the synchronization pulse input signal and the video format.

26. The apparatus of claim 19, further comprising a register configured to store determined timing errors.

27. The apparatus of claim 19, wherein the comparator is configured to:
determine the at least one search region window based on the video format and the synchronization pulse input signal; and
periodically determine the timing error based on the active video input data included in the active video input signal being received within the at least one search region window.
